(19) United States
(12) Patent Application Publication
(10) Pub. No.: US 2025/0261634 A1
(43) Pub. Date: Aug. 21, 2025

(54) LIQUID HERBICIDAL COMPOSITIONS

(71) Applicant: UPL LTD, Mumbai (IN)

(72) Inventors: Achintya Mondal, Mumbai (IN); Satish Ekanath Bhoge, Mumbai (IN)

(21) Appl. No.: 19/175,204

(22) Filed: Apr. 10, 2025

Related U.S. Application Data
(62) Division of application No. 17/687,179, filed on Mar. 4, 2022.

(30) Foreign Application Priority Data
Mar. 4, 2021 (IN) 202121009175

(51) Int. Cl. A01N 25/02; A01N 25/30; A01N 57/20

(52) U.S. Cl. CPC A01N 25/02; A01N 25/30; A01N 57/20

(57) ABSTRACT

Disclosed herein is a liquid agrochemical composition. Also disclosed is a process of preparing the liquid agrochemical composition, use of the liquid composition for controlling the weeds and a method of controlling weeds using the liquid agrochemical composition. The composition includes an electrolytic agrochemical; a non-hydrotrope phosphorus derivative; a surfactant; and an electrolyte, wherein the electrolyte is not a surfactant.

### CROSS-REFERENCE TO RELATED APPLICATIONS

This application claims priority to U.S. application Ser. No. 17/687,179, filed Mar. 4, 2022, and claims priority to Indian Patent Publication 202121009175, filed on Mar. 4, 2021, both of which are incorporated herein by reference in their entireties.

### TECHNICAL FIELD OF THE DISCLOSURE

The disclosure pertains to liquid agrochemical compositions including an electrolytic agrochemical as an active ingredient, a process of preparing the liquid agrochemical compositions, and a method of controlling weeds using the liquid agrochemical compositions.

### BACKGROUND

Water-soluble herbicidal ingredients used as non-selective, foliar treatment agents are widely used and effective crop protection agents. For example, U.S. Pat. No. 4,168,963 discloses 2-amino-4-[hydroxy(methyl)phosphinoyl]butyric acid (glufosinate). The salts and isomers of glufosinate possess good and broad activity against weeds of many botanical species. Glufosinate is a non-selective, contact herbicide, with some systemic action. Application of glufosinate to weeds leads to reduced glutamine levels and elevated ammonia levels in weed tissues, halting photosynthesis and resulting in weed plant death.

The L-enantiomer of glufosinate is considered to be the biologically active isomer. The herbicidal activity of the L-isomer is twice that of the racemate, and the use of the L-isomer offers clear advantages, such as a reduced application rate and decreased side effects.

Glufosinate is used to control persistent weeds such as morning glories, hemp sesbania (Sesbania bispinosa), Pennsylvania smartweed (Polygonum pensylvanicum) and yellow nutsedge.

Glufosinate is most often used as a directed spray for weed control in crops, including in genetically modified crops, and also as a crop desiccation agent to facilitate harvesting.

In the case of water-soluble herbicides such as glufosinate, the nature and the amount of the adjuvants co-formulated with glufosinate can affect the activity of the formulation.

There remains a need to find suitable adjuvants which effectively increase the performance of an agrochemical composition including, for example, glufosinate and/or L-glufosinate.

### SUMMARY

It is an objective of the present disclosure to provide highly efficacious liquid agrochemical compositions.

Yet another objective of the disclosure is to provide highly efficacious liquid agrochemical compositions having a specific dynamic surface tension (DST).

Yet another objective of the disclosure is to provide a method for controlling weeds with efficacious liquid agrochemical compositions having a specific DST.

Yet another objective of the present disclosure is to provide a method of controlling weeds employing the liquid agrochemical compositions.

The present disclosure provides a liquid agrochemical composition comprising:
a) an electrolytic agrochemical;
b) a non-hydrotrope phosphorus derivative;
c) at least one surfactant; and
d) an electrolyte, wherein the electrolyte is not a surfactant.

The present disclosure provides a liquid agrochemical composition comprising:
a) an electrolytic agrochemical;
b) a non-hydrotrope phosphorus derivative;
c) at least one surfactant; and
d) an electrolyte, wherein the electrolyte is not a surfactant, and wherein when the composition is diluted to provide a spray solution, the spray solution of the agrochemical liquid composition has a dynamic surface tension of less than 60 mN/m at a surface age of 20-50 milliseconds.

The present disclosure provides a process of preparing the disclosed liquid agrochemical composition, comprising:
combining the electrolytic agrochemical, a solvent and optionally an excipient to obtain a dispersion;
combining the non-hydrotrope phosphorus derivative, a surfactant, the electrolyte, wherein the electrolyte is not a surfactant, and the water with the dispersion to obtain the liquid agrochemical composition.

The present disclosure provides a method of controlling weeds by applying a liquid agrochemical composition for controlling weeds, the liquid agrochemical composition comprising:
a) an electrolytic agrochemical;
b) a non-hydrotrope phosphorus derivative;
c) at least one surfactant; and
d) an electrolyte, wherein the electrolyte is not a surfactant.

The present disclosure provides a method of controlling weeds comprising applying to a plant or to a locus at which the plant is growing or intended to be grown, an effective amount of the disclosed liquid agrochemical composition.

### DETAILED DESCRIPTION

For the purposes of the following detailed description, it is to be understood that the disclosure may assume various alternative variations except where expressly specified to the contrary. Moreover, other than in any operating examples, or where otherwise indicated, all numbers expressing, for example, quantities of materials/ingredients used in the specification are to be understood as being modified in all instances by the term “about”.

Unless otherwise defined, all technical and scientific terms used herein have the same meaning as commonly understood by one of ordinary skill in the art to which this disclosure pertains. In the case of conflict, the present document, including definitions will control.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

As used herein, “a,” “an,” “the,” and “at least one” do not denote a limitation of quantity and are intended to cover both the singular and plural, unless the context clearly indicates otherwise. For example, “an element” has the same meaning as “at least one element,” unless the context clearly indicates otherwise. The terms first, second etc. as used herein are not meant to denote any particular ordering, but simply for convenience to denote a plurality of, for example, layers. As used herein, the terms “comprising” “including,” “having,” “containing,” “involving,” and the like are to be understood to be open-ended, i.e., to mean “including” but not limited to, unless otherwise noted. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

In any aspect or embodiment described hereinbelow, the phrase comprising may be replaced by the phrases “consisting of” or “consisting essentially of” or “consisting substantially of”. In these aspects or embodiment, the composition described includes or comprises, or consists of, or consists essentially of, or consists substantially of the specific components recited therein, to the exclusion of other ingredients or excipients not specifically recited therein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context.

“Alkyl” means a straight or branched chain saturated aliphatic hydrocarbon having the specified number of carbon atoms, specifically 1 to 12 carbon atoms, more specifically 1 to 6 carbon atoms. Alkyl groups include, for example, groups having from 1 to 50 carbon atoms (C1 to C50 alkyl).

“Aryl” means a cyclic moiety in which all ring members are carbon and at least one ring is aromatic, the moiety having the specified number of carbon atoms, specifically 6 to 24 carbon atoms, more specifically 6 to 12 carbon atoms. More than one ring may be present, and any additional rings may be independently aromatic, saturated or partially unsaturated, and may be fused, pendant, spirocyclic or a combination thereof.

“Alkylene” means a straight or branched chain, saturated, divalent aliphatic hydrocarbon group, (e.g., methylene (—CH2-) or, propylene (—(CH2)3-)).

As used throughout the disclosure, an electrolytic agrochemical or other active ingredients, includes their salts, esters, ethers, isomers, and polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods. A “solvate” means the herbicide or its agriculturally acceptable salt, wherein molecules of a suitable solvent are incorporated in the crystal lattice. A suitable solvent is physiologically tolerable at the dosage administered. Examples of suitable solvents are ethanol, water and the like. When water is the solvent, the molecule is referred to as a “hydrate”. The formation of solvates will vary depending on the compound and the solvate. In general, solvates are formed by dissolving the compound in the appropriate solvent and isolating the solvate by cooling or using an antisolvent. The solvate is typically dried or azeotroped under ambient conditions. In an aspect, the solvate is a hydrate.

The term “plant” refers to all physical parts of a plant, including seeds, seedlings, saplings, roots, tubers, stems, stalks, foliage and fruits. The term plant includes transgenic and non-transgenic plants.

The term “locus” as used herein refers to the vicinity, area, or place in which the plants are growing, where plant propagation materials of the plants are sown (e.g., placed into the soil), and/or where the plant propagation materials of the plants will be sown.

The term “plant propagation material” refers to the generative parts of a plant, such as seeds, vegetative material such as cuttings or tubers, roots, fruits, tubers, bulbs, rhizomes, and other parts of plants, germinated plants, and/or young plants, which are to be transplanted after germination or after emergence from the soil. These young plants may be protected prior to transplantation by a total or partial immersion treatment/system.

As used herein, “effective amount” is an amount of active ingredient, such as the disclosed combinations, which has an adverse effect on the weeds and/or which controls the weeds in a plant. The adverse effect can include killing of the weeds (herbicidal), preventing growth of the weeds, blocking of biosynthetic pathway(s), or a combination thereof.

As used herein, an “agriculturally acceptable salt” means a salt which is accepted for use in agricultural or horticultural use.

As used herein the term “electrolytic agrochemical” means an agrochemical which will form ions when dissolved in water at 20° C. The term “agrochemical” refers to an active ingredient that can kill, repel or inhibit the growth or reproduction of an unwanted organism (“pests”), or can protect or promote the healthy growth or reproduction of wanted organisms such as plants (e.g., crops, ornamentals), and can be used for example for application to fields, crops, orchards, gardens, forestry, shrub hedges, parks, industrial parks, construction sites, airports, roads, railways, rivers, lakes, ponds, canals, irrigation and drainage projects. The electrolytic agrochemical may be a pesticide, for example an herbicide, fungicide or insecticide. For the purposes of the present disclosure, the electrolytic agrochemical is an herbicide.

Glufosinate has the chemical name 2-amino-4-[hydroxy(methyl)phosphoryl]butanoic acid. L-glufosinate, also known commercially as glufosinate-P, is an isomer of glufosinate.

It has been surprisingly and unexpectedly discovered that a liquid composition comprising an electrolytic agrochemical, a non-hydrotrope phosphorus derivative, a surfactant, and an electrolyte, wherein the electrolyte is not a surfactant, provides a composition with the best dynamic surface tension profiles, leading to a highly bio-efficacious formulation. It was further discovered that the liquid composition comprising an electrolytic agrochemical, a non-hydrotrope phosphorus derivative, a surfactant, and an electrolyte, wherein the electrolyte is not a surfactant, is capable of pinning droplets of the formulation to the plant surface such that the droplets do not bounce and/or roll off the plant surface. As used herein “pinning” of a droplet comprises retaining at least a portion or substantially all of the liquid present in the droplet on the plant surface for a sufficient period of time to result in the efficacy of the agrochemical (herbicide) present in the formulation.

Aqueous formulations of water-soluble herbicides, such as glufosinate, have a tendency to be washed off by rain or may not remain on the leaf surface long enough to be taken up by the plant. To be effective, pinning droplets of the formulation to the plant surface is extremely important to ensure contact between the herbicide and the plant occurs for a sufficient period of time to facilitate wetting and spreading of the droplet on the leaf surface, and to facilitate leaf penetration and translocation of the herbicide.

The action of a surfactant is a result of its partly hydrophilic and partly hydrophobic nature, which allows the surfactant to adsorb at interfaces, separating media of different polarity. For example, a liquid film is generally intended to spread over a solid surface or another liquid surface, an action generally referred to as “wetting.” This will occur spontaneously if the liquid film or droplet has a lower surface tension than the surface it covers. By reducing surface tension, surfactants therefore promote wetting.

Dynamic surface tension (DST) directly impacts the quality of wetting, spreading, and sticking of the ingredients to the plant surface. Dynamic surface tension is fairly correlated with dynamic wetting conditions on a plant surface in an actual field spray environment. The concentration and the activity of the surfactant not only determines by how much the surface tension is reduced, but also the speed at which the diffusion takes place and how fast wetting will occur. Formulators can improve transferring, wetting, spreading and sticking of a formulation by determining the best surfactant concentrations through dynamic critical micelle concentration (CMC) determination, and by choosing surfactant and additive combinations that provide the best dynamic surface tension profiles for their specific application.

The wetting of surfaces takes place on a time scale that is in the order of milliseconds; consequently, the adsorption kinetics of surfactant molecules to the plant surface is of critical importance when choosing surfactant and additive combinations. Contact angle measurement or contact angle hysteresis is another important tool in understanding the surface tension properties of the formulation and the impact of surfactants in providing the required spreading and sticking properties for the active ingredient. It further envisages the optimum droplet deposition pattern of the formulation on the leaf surface required for rendering uniform distribution of the active ingredient resulting in better performance.

It has been advantageously discovered that highly efficacious formulations can be achieved if the surfactant and additive combinations, as well as the final formulation, lead to a spray solution having a DST in a specific range.

The inventors observed that the combination of specific surfactants that provide formulations and spray solutions having the best dynamic surface tension profiles, improve the wetting of the plant surface ensuring that the active substance adheres to the plant surface for a longer period of time and/or is better taken up by the plant consequentially leading to a highly efficacious product.

With respect to the present disclosure the terms “composition” and “formulation” are used interchangeably.

The advantages and novel features of the present disclosure will become apparent from the following detailed description of various non-limiting embodiments of the disclosure when considered in conjunction with the accompanying examples.

Accordingly, the present disclosure provides an agrochemical liquid composition comprising:
a) an electrolytic agrochemical;
b) a non-hydrotrope phosphorus derivative;
c) at least one surfactant; and
d) an electrolyte which is not a surfactant.

In an embodiment, the agrochemical liquid composition comprises one or more additional active ingredients.

In an embodiment, non-hydrotrope phosphorus derivatives are compounds composed of a hydrophilic part and a hydrophobic part, wherein the hydrophobic part is large enough to impart spontaneous assembly into micelles or other aggregates. In an embodiment, the non-hydrotrope phosphorus derivative comprises a C8-C20 alkyl group as the hydrophobic part of the molecule.

In an embodiment, non-hydrotrope phosphorus derivatives are compounds capable of solubilizing hydrophobic compounds in aqueous solutions by micellar solubilization.

In an embodiment, non-hydrotrope phosphorus derivatives are compounds having a certain critical micelle concentration. The critical micelle concentration (CMC) is defined as the concentration of above which micelle formation of the non-hydrotrope phosphorus derivative spontaneously occurs and at which all additional surfactants present in the system will also form micelles.

With respect to the present disclosure, the term Dynamic Surface Tension (DST) or Interfacial Tension (IFT) is the value of a particular surface age or interface age. The surface age is the period of time from the beginning of the creation of a surface to the time of the observation or measurement. The interface age is the period of time from the beginning of the creation of an interface to the time of the observation or measurement. The time-dependent value is referred to as the Dynamic Surface Tension (DST). In the case of liquids including surface-active substances (surfactants), DST differs from measurement of equilibrium Surface Tension value, which is a static measurement and non-time dependent.

With respect to the present disclosure, the terms “surface age”, “interface age” and “bubble age” are used interchangeably. Dynamic Surface Tension (DST) is expressed as force per unit of width, specifically, as milliNewtons per meter (mN/m).

In an embodiment, dynamic surface tension is measured over a surface age range of 10-200 milliseconds, or over a range of 10-100 milliseconds, or over a range of 20-50 milliseconds.

In an embodiment, dynamic surface tension is measured over a surface age range of 10-100 milliseconds.

In an embodiment, dynamic surface tension is measured over a surface age range of 20-50 milliseconds.

In an embodiment, the electrolytic agrochemical active ingredient is present in a neutralised form in the aqueous solution.

In an embodiment, the electrolytic agrochemical active ingredient is present in a salt form.

In an embodiment, the electrolytic agrochemical active ingredient in a salt form is obtained by neutralization of the acid form and subsequent conversion to salt form.

In an embodiment, the electrolytic agrochemical active ingredient is a water-soluble salt of glufosinate or an isomer thereof, or a combination thereof.

In an embodiment, the electrolytic agrochemical active ingredient is an optically active isomer of glufosinate (referred to as L-glufosinate hereinafter) or a water-soluble salt thereof, or a combination thereof.

In an embodiment of the present disclosure, the electrolytic agrochemical active ingredient includes a water soluble salt of glufosinate, wherein the salt includes a hydrochloride salt, a monosodium salt, disodium salt, a monopotassium salt, a dipotassium salt, a monocalcium salt, an ammonium salt, NH3(CH3)+ salt, NH2(CH3)2+ salt, NH(CH3)3+ salt, NH(CH3)2(C2H4OH)+ salt, NH2(CH3)(C2H4OH)+ salt, or a combination thereof.

In an embodiment, the electrolytic agrochemical active ingredient is a water-soluble sodium and/or ammonium salt of glufosinate. In an embodiment, the electrolytic agrochemical active ingredient is glufosinate sodium, glufosinate ammonium, or a combination thereof.

In an embodiment of the present disclosure, the electrolytic agrochemical active ingredient includes a water soluble salt of L-glufosinate, wherein the salt includes hydrochloride salt, a monosodium salt, a disodium salt, a monopotassium salt, a dipotassium salt, a monocalcium salt, an ammonium salt, NH3(CH3)+ salt, NH2(CH3)2+ salt, —NH(CH3)3+ salt, NH(CH3)2(C2H4OH)+ salt, —NH2(CH3)(C2H4OH)+ salt, or a combination thereof.

In an embodiment of the present disclosure, the electrolytic agrochemical active ingredient includes a water-soluble sodium and/or ammonium salt of L-glufosinate. In an embodiment, the electrolytic agrochemical active ingredient is L-glufosinate sodium, L-glufosinate ammonium, or a combination thereof.

In an embodiment, the liquid agrochemical compositions comprise from about 0.1% to about 99% by weight of the water-soluble salt of glufosinate or an isomer thereof based on the total weight of the liquid agrochemical composition.

In an embodiment, the liquid agrochemical compositions comprise from about 1 to about 50% by weight of glufosinate or an isomer thereof based on the total weight of the liquid agrochemical composition.

In an embodiment, the liquid agrochemical compositions comprise from about 5 to about 40% by weight of the water-soluble salt of glufosinate or an isomer thereof based on the total weight of the liquid agrochemical composition.

In an embodiment, the liquid agrochemical compositions comprise from about 10 to about 30% by weight, of the water-soluble salt of glufosinate or an isomer thereof based on the total weight of the liquid agrochemical composition.

In an embodiment, the present disclosure provides an agrochemical liquid composition comprising:
a) an electrolytic agrochemical in the neutralised form;
b) a non-hydrotrope phosphorus derivative comprising a C₈-C₂₀ alkyl group;
c) a surfactant, and
d) an electrolyte which is not a surfactant.

In an embodiment, the electrolytic agrochemical active ingredient is a salt of glufosinate, an isomer thereof, or a combination thereof.

In an embodiment, the electrolytic agrochemical is glufosinate ammonium.

In an embodiment, the liquid agrochemical composition is diluted to a spray solution containing an agronomically effective amount of an electrolytic agrochemical per litre of the spray solution.

In an embodiment, the liquid agrochemical composition is diluted to a spray solution containing an agronomically effective amount of glufosinate per litre of the spray solution.

In an embodiment, a spray dilution of the liquid agrochemical compositions at a spray dilution, have a Dynamic Surface Tension (DST) of less than 60 mN/m at a surface age of 20-50 milliseconds, i.e., at each time across the range of 20 to 50 milliseconds.

In an embodiment, the liquid agrochemical composition is diluted to a spray solution containing about 0.1 g to about 10 g of electrolytic agrochemical per litre of the spray solution. In an embodiment, the electrolytic agrochemical is a water-soluble salt of glufosinate or an isomer thereof or a combination thereof.

In an embodiment, the liquid agrochemical composition is diluted to a spray solution containing about 0.1 g to about 5 g of electrolytic agrochemical per litre of the spray solution. In an embodiment, the electrolytic agrochemical is a water-soluble salt of glufosinate or an isomer thereof or a combination thereof.

In an embodiment, the liquid agrochemical compositions are diluted to spray solutions using a solvent, preferably water.

In an embodiment the present disclosure provides an agrochemical liquid composition comprising:
a) L-glufosinate ammonium, L-glufosinate sodium or a combination thereof;
b) a non-hydrotrope phosphorus derivative comprising a C₈-C₂₀ alkyl group;
c) a surfactant; and
d) an electrolyte which is not a surfactant,
wherein when the composition is diluted to provide a spray solution, the spray solution has a DST less than 60 mN/m at a surface age of 20-50 milliseconds.

In an embodiment, the liquid agrochemical composition is diluted to a spray solution containing an agronomically effective amount of L-glufosinate per litre of the spray solution.

In an embodiment, the liquid agrochemical composition is diluted to a spray solution containing about 0.1 g to about 10 g of L-glufosinate per litre of the spray solution.

In an embodiment, the liquid agrochemical composition is diluted to a spray solution containing about 0.1 g to about 2.5 g of L-glufosinate per litre of spray solution.

In an embodiment, the compositions are diluted to spray solutions using a solvent, preferably water.

In an embodiment, the non-hydrotrope phosphorus derivative is a C8-C20 fatty alcohol alkoxylate phosphate, wherein a degree of alkoxylation is in a range from about 3 to about 15 moles per mole of alcohol.

In an embodiment, the non-hydrotrope phosphorus derivative is a C8-C20 fatty alcohol ethoxylate phosphate, also interchangeably referred to herein as a C8-C20 fatty alcohol alkyl ether phosphate derivative.

In an embodiment, the non-hydrotrope phosphorus derivative is tridecyl alcohol ethoxylate phosphate ester, polyethylene glycol monotridecyl ether phosphate, or a combination thereof.

In an embodiment, the composition comprises the non-hydrotrope phosphorus derivative in an amount from about 0.1% to about 30% by weight based on the total weight of the liquid agrochemical composition.

In an embodiment, the composition comprises the non-hydrotrope phosphorus derivative in an amount from about 5% to about 25% by weight based on the total weight of the liquid agrochemical composition.

In an embodiment, the composition comprises the non-hydrotrope phosphorus derivative in an amount from about 10% to about 20% by weight, based on the total weight of the liquid agrochemical composition.

In an embodiment, the compositions according to the present disclosure comprise at least one surfactant. As disclosed in U.S. Pat. No. 6,642,177, glufosinate is generally formulated with a high concentration of surfactant, for example, about 110 parts surfactant (such as a tallow amine ethoxylate) to 100 parts of glufosinate active ingredient.

However, in the compositions of the present disclosure, the amount of surfactant is substantially decreased compared to prior art compositions.

In an embodiment, the composition comprises the surfactant in an amount from about 0.1% to about 50% by weight based on the total weight of the liquid agrochemical composition.

In an embodiment, the composition comprises the surfactant in an amount from about 1% to about 40% by weight based on the total weight of the liquid agrochemical composition.

In an embodiment, the composition comprises the surfactant in an amount from about 5% to about 30% by weight, based on the total weight of the liquid agrochemical composition.

In an embodiment, the surfactant comprises a C8-C15 alkyl polyglycoside, an N-alkyl glucamide, a C8-C20 alkyl dimethylamine N-oxide, or a combination thereof.

In an embodiment, the surfactant is a C8-C15 alkyl polyglycoside having an average degree of polymerization of 1 to 3.

In an embodiment, the surfactant is a C8 to C11 alkyl polyglycoside having an average degree of polymerization of 1 to 2.

In an embodiment, the composition comprises the C8-C15 alkyl polyglycoside in an amount from about 0.1% to about 30% by weight of the composition.

In an embodiment, the N-alkyl glucamide is a D-glucitol, 1-deoxy-1-(C1-C5 alkyl-amino)-N—(C5-C10) acyl derivative.

In an embodiment, the N-alkyl glucamide is a D-glucitol, 1-deoxy-1-(C1-C3 alkyl-amino)-N—(C8-C10) acyl derivative.

In an embodiment, the composition comprises N-alkyl glucamide in an amount from about 0.1% to about 30% by weight based on the total weight of the liquid agrochemical composition.

In an embodiment, the composition comprises N-alkyl glucamide in an amount from about 1% to about 25% by weight based on the total weight of the liquid agrochemical composition.

In an embodiment, the composition comprises N-alkyl glucamide in an amount from about 2% to about 20% by weight, based on the total weight of the liquid agrochemical composition.

In an embodiment, the surfactant is a C8-C20 alkyldimethyl amine N-oxide in which the nitrogen atom of the amine oxide is substituted with at least one C8 to C20 long chain aliphatic group. Examples of the C8-C20 alkyldimethyl amine N-oxide include decyl, dodecyl, tetradecyl, pentadecyl, hexadecyl, and octadecyl dimethyl amine N-oxides.

In an embodiment, the composition comprises the C8-C20 alkyldimethyl amine N-oxide in an amount from about 0.1% to about 50% by weight of the composition.

In an embodiment, the composition comprises the C8-C20 alkyldimethyl amine N-oxide in an amount from about 5% to about 45% by weight of the composition.

In an embodiment, the composition comprises the C8-C20 alkyldimethyl amine N-oxide in an amount from about 10% to about 30% by weight of the composition.

In an embodiment, the liquid agrochemical composition comprises an electrolyte, and the electrolyte is not a surfactant.

In an embodiment, the electrolyte comprises an inorganic salt of an alkali or alkaline earth metal.

In an embodiment, the inorganic salt of the alkali or alkaline earth metal salt includes magnesium chloride, magnesium sulfate, potassium chloride, potassium sulfate, potassium carbonate, sodium chloride, sodium carbonate, sodium chlorate, sodium nitrate, sodium sulfate, calcium chloride, calcium carbonate, calcium nitrate, or a combination thereof.

In an embodiment, the liquid agrochemical composition comprises the electrolyte in an amount from about 0.1% to about 20% by weight based on the total weight of the liquid agrochemical composition.

In an embodiment, the liquid agrochemical composition comprises the electrolyte in an amount from about 0.1% to about 10% by weight based on the total weight of the liquid agrochemical composition.

In an embodiment, the liquid agrochemical composition comprises the electrolyte in an amount from about 0.2 to about 2% by weight, based on the total weight of the liquid agrochemical composition.

In an embodiment, the present disclosure provides a liquid agrochemical composition comprising:
a) a glufosinate salt;
b) a non-hydrotrope C₈-C₂₀ fatty alcohol alkoxylate phosphate;
c) a surfactant; and
d) an alkali metal salt.

In an embodiment, the present disclosure provides a liquid agrochemical composition comprising:
a) a glufosinate salt;
b) a non-hydrotrope C₈-C₂₀ fatty alcohol alkoxylate phosphate;
c) a surfactant; and
d) an alkali metal salt,
wherein when the composition is diluted to provide a spray solution, the spray solution has a dynamic surface tension less than 60 mN/m at a surface age of 20-50 milliseconds.

In an embodiment, the liquid agrochemical composition comprises:
a) glufosinate ammonium;
b) a non-hydrotrope C₈-C₂₀ fatty alcohol alkoxylate phosphate;
c) a C₈-C₁₀ alkyl polyglycoside; and
d) potassium chloride,
wherein when the composition is diluted to provide a spray solution, the spray solution has a dynamic surface tension less than 60 mN/m between a surface age of 20-50 milliseconds.

In an embodiment, the agrochemical liquid composition comprises:
a) L-glufosinate salt;
b) a non-hydrotrope C₈-C₂₀ fatty alcohol alkoxylate phosphate;
c) at least one surfactant; and
d) an alkali metal salt,
wherein when the composition is diluted to provide a spray solution, the spray solution has a dynamic surface tension less than 60 mN/m between a surface age of 20-50 milliseconds.

In an embodiment, the agrochemical liquid composition comprises:
a) L-glufosinate salt;
b) A non-hydrotrope C₈-C₂₀ fatty alcohol alkoxylate phosphate;
c) at least one surfactant; and
d) an alkali metal salt,
wherein when the composition is diluted to provide a spray solution, the spray solution has a dynamic surface tension less than 60 mN/m at a surface age of 20-50 milliseconds.

In an embodiment, the liquid agrochemical composition comprises:
a) L-glufosinate sodium;
b) a non-hydrotrope C₈-C₂₀ fatty alcohol alkoxylate phosphate;
c) D-Glucitol 1-deoxy-1-(C₁-C₃ alkyl-amino)-N—(C₈-C10) acyl derivatives, and
d) potassium sulfate,
wherein when the composition is diluted to provide a spray solution, the spray solution has a dynamic surface tension less than 60 mN/m at a surface age of 20-50 milliseconds.

In an embodiment the liquid agrochemical composition comprises:
a) 1-glufosinate ammonium;
b) non-hydrotrope C₈-C₂₀ fatty alcohol alkoxylate phosphate;
c) Decylamine oxide; and
d) magnesium chloride,
wherein when the composition is diluted to provide a spray solution, the spray solution has a dynamic surface tension less than 60 mN/m between a surface age of 20-50 milliseconds.

In an embodiment, the liquid agrochemical compositions further comprise at least one solvent.

In an embodiment, the solvent is selected from, but not limited to, a water miscible polar/non-polar solvent or a water immiscible polar/non-polar solvent. For example, the organic solvent may include alkyl esters of phthalic acid and trimellitic acid; aromatic hydrocarbons such as xylene, alkyl benzenes; methylnaphthalene; mixtures of aromatic, aliphatic and/or cycloaliphatic hydrocarbon such as hexanes and heptanes; ketones such as cyclohexanone, 2-octanone, acetophenone, methyl isobutyl ketone, saturated or unsaturated cyclic ketones such as isophorone; chlorinated hydrocarbons; vegetable oils such as castor oil and modified vegetable oils; glycols and their derivatives; aliphatic alcohols; alkoxy aliphatic alcohols; glycols and their derivatives such as propylene glycol, dipropylene glycol, polypropylene glycol, monoethylene glycol, diethylene glycol, polyethlene glycol; alkoxy aliphatic alcohols such as 1-methoxy 2-propanol, butoxy ethanol; esters such as methyl ester of C₈-C₂₀ fatty acids; or a combination comprising at least one of the foregoing solvents.

The processes for formulating the highly efficacious liquid agrochemical formulations disclosed herein are not limited.

The processes for preparing the spray solutions according to the present disclosure are also not limited.

In an embodiment, the spray solutions can be prepared by processes including, but not limited to, in-can formulations and tank mixing with other formulation products. Application of the spray solution may be pre- or post-emergence.

Post emergence application of the spray solution comprising the formulations according to the present disclosure is preferred. Such spray solutions may be made up by simple dilution of the liquid agrochemical compositions or by mixing of the individual components of the composition and adding further individual herbicides or mixtures of herbicides. Spray solutions comprising formulations according to the present disclosure may further comprise other components which are desired to be applied to the plants or their environment.

Preferably, such end use mixing is carried out in the tank from which the formulation is sprayed, or alternatively in a holding tank for filling the spray tank.

In an embodiment of the present disclosure, the liquid agrochemical compositions may further comprise an additional active ingredient, selected from various classes of agrochemicals including herbicides, insecticides, and fungicides. In an embodiment, the additional active ingredient is an herbicide.

The active ingredients may be a water soluble or water insoluble herbicide, examples of which include:
diphenyl ether herbicides such as oxyfluorfen, acifluorfen, lactofen, fomesafen and their salts;
pyrimidinyloxybenzoic analogue herbicides such as pyrithiobac sodium and bispyribac sodium;
organophosphrous based herbicides such as glyphosate, bilanafos, bialaphos, and their salts;
Bipyridinium herbicides such as paraquat and diquat and salts thereof;
aryloxyalkanoic acid herbicides such as 2, 4-D, 2-methyl-chloropehnoxyacetic acid (MCPA), 4-(4-chloro-o-tolyloxy)butyric acid) (MCPB) and their salts;
aryloxyphenoxypropionic herbicides such as haloxyfop, its isomers and esters, clodinafop and its esters;
pyridine herbicides such as triclopyr, picloram, aminopyralid and salts thereof;
aromatic herbicides such as dicamba, 2,3,6-trichlorobenzoic acid (2,3,6-TBA), tricamba and their salts;
pyridine carboxylic acid herbicides such as clopyralid, triclopyr;
imidazolinones such as imazameth, imazamethabenz, imazamox, imazapic, imazapyr, imazaquin, imazethapyr;
sulfonylurea herbicides such as flazasulfuron, rimsulfuron, bensulfuron, ethoxysulfuron, mesosulfuron, oxasulfuron, pyrazosurfuron-ethyl and their salts;
cyclohexanedione oxime herbicides such as clethodim and its salts;
chloroacetamide herbicides such as metolachlor and its salts and isomers;
phenyl phthalimide herbicides such as flumioxazin, mesotrione, topramezone, tembotrione, quinotrione and their salts;
dinitroaniline herbicides such as oryzalin, pendimethalin, profluralin, trifluralin and their salts;
bicyclic dicarboxylic acid herbicides such as endothall, halauxifen, pyriflauxifen, prosulfuron and primisulfuron, cinmethylin, pyroxasulfone and their salts;
or a combination comprising at least one of the foregoing herbicides.

In an embodiment, the disclosed liquid agrochemical composition further comprises at least one agrochemically acceptable excipient.

The liquid agrochemical composition according to the present disclosure may further comprise other agronomically suitable excipients such as surfactants, solvent, fertilizer, pH modifiers, crystallization inhibitors, viscosity modifiers, suspension agents, spray droplet modifiers, pigments, antioxidants, foaming agents, light-blocking agents, compatibilizing agents, antifoam agents, sequestering agents, neutralizing agents, corrosion inhibitors, dyes, odorants, spreading agents, penetration aids, micronutrients, emollients, lubricants, sticking agents, dispersing agents, thickening agents, freezing point depressants, and antimicrobial agents.

In an embodiment of the present invention, the surfactants may be selected from anionic, cationic or zwitterionic surface active compounds and/or nonionic surface active compounds (surfactants). Examples of anionic surfactants include: anionic derivatives of fatty alcohols having 10-24 carbon atoms in the form of ether carboxylates, sulfonates, sulfates, and phosphates, and their inorganic salts (e.g., alkali metal and alkaline earth metal salts) and organic salts (e.g., salts based on amine or alkanolamine); anionic derivatives of copolymers consisting of EO (ethylene oxide), PO (propylene oxide) and/or BO (butylene oxide) units, in the form of ether carboxylates, sulfonates, sulfates, and phosphates, and their inorganic salts (e.g., alkali metal and alkaline earth metal salts) and organic salts (e.g., salts based on amine or alkanolamine); derivatives of alkylene oxide adducts of alcohols, in the form of ether carboxylates, sulfonates, sulfates and phosphates, and their inorganic salts (e.g., alkali metal and alkaline earth metal salts) and organic salts (e.g., salts based on amine or alkanolamine); derivatives of fatty acid alkoxylates, in the form of ether carboxylates, sulfonates, sulfates and phosphates, and their inorganic salts (e.g., alkali metal and alkaline earth metal salts) and organic salts (e.g., salts based on amine or alkanolamine).

Examples of cationic or zwitterionic surfactants include alkylene oxide adducts of fatty amines, quaternary ammonium compounds having 8 to 22 carbon atoms (C8-C22), and surface-active zwitterionic compounds such as taurides, betaines and sulfobetaines.

Examples of non-ionic surfactants include: fatty alcohols having 10-24 carbon atoms with 0-60 EO and/or 0-20 PO and/or 0-15 BO units in any order; fatty acid alkoxylates and triglyceride alkoxylates; fatty acid amide alkoxylates; alkylene oxide adducts of alkyne diols; sugar derivatives such as amino sugars and amido sugars; polyacrylic and polymethacrylic derivatives; polyamides such as modified gelatins or derivatized poly aspartic acid; surfactant polyvinyl compounds such as modified PVP; polyol-based alkylene oxide adducts; polyglycerides, and derivatives thereof.

The anti-foaming agents may include, but are not limited to, silicone based and non-silicone based agents. The silicone based agents may include silicone oil, polydimethylsiloxane, and modified siloxane, and the non-silicone based agents may include mineral oil based antifoams, vegetable oils, fatty acids and fatty acid derivatives, fatty amines and fatty amine derivatives, fatty acid amides, substituted fatty acid amides and fatty acid amide derivatives, polyalkylene glycol, and tributyl phosphate.

The colouring agents is not limited and may be selected from various formulation dyes known in the art.

In an embodiment, the present disclosure provides the use of the disclosed liquid agrochemical composition for controlling weeds, the agrochemical liquid composition comprising:
a) an electrolytic agrochemical;
b) a non-hydrotrope phosphorus derivative;
c) a surfactant; and
d) an electrolyte, wherein the electrolyte is not a surfactant.

In an embodiment, the present disclosure provides the use of the disclosed liquid agrochemical composition for controlling weeds, wherein the liquid agrochemical composition is diluted to a spray solution containing about 0.1 g to about 10 g of glufosinate or isomer thereof per litre of the spray solution. In an embodiment, the liquid agrochemical is diluted to a spray solution comprising about 0.1 g to about 5 g of glufosinate or isomer thereof per litre of the spray solution.

In an embodiment, the present disclosure further provides a method of controlling weeds comprising applying to a plant or to a locus at which the plant is growing or intended to be grown, an agronomically effective amount of a liquid agrochemical composition comprising:
a) an electrolytic agrochemical;
b) a non-hydrotrope phosphorus derivative;
c) a surfactant; and
d) an electrolyte, wherein the electrolyte is not a surfactant.

In an embodiment the disclosure provides a method of controlling unwanted plants in pre-plant, burn down segments or to crops that are resistant or tolerant to glufosinate or its isomers (e.g., L-glufosinate), said method comprising applying to the plants, unwanted plants or to their locus an agronomically effective amount of a liquid agrochemical composition comprising:
a) a salt of glufosinate or an isomer thereof;
b) a non-hydrotrope phosphorus derivative comprising a C₈-C₂₀ alkyl group;
c) a surfactant, and
an electrolyte which is not a surfactant.

In an embodiment, a method of controlling unwanted plants in pre-plant, burn down segments or to crops that are resistant or tolerant to glufosinate or an isomers thereof (L-glufosinate) comprising applying to the unwanted plants or crop or to a locus at which the plant or crop is growing or intended to be grown an effective amount of a liquid agrochemical composition comprising
a) L-glufosinate salt;
b) a non-hydrotrope phosphorus derivative comprising a C₈-C₂₀ alkyl group;
c) a surfactant, and
d) an electrolyte which is not a surfactant,
wherein when the composition is diluted to provide a spray solution, the spray solution has a dynamic surface tension less than 60 mN/m between a surface age of 20-50 milliseconds.

In an embodiment, the disclosure provides a method of controlling grass and/or broadleaf species comprising applying to the grass and/or broadleaf species or to a locus at which the grass and/or broadleaf species are growing, an effective amount of the liquid agrochemical compositions disclosed herein.

Examples of the crops on which the present compositions may be used used include, are not limited to, corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an embodiment, the weeds controlled by the present compositions include but are not limited to Chinopodium album Amaranthus palmeri, Brachiaria plantaginea, Amaranthus viridis, green fox tail, morning glory, volunteer soybean, Brachiaria decumbens and Eleusine indica.

The liquid agrochemical compositions may be sold as a pre-mixed composition. Alternatively, the components of the liquid agrochemical may be provided individually as separate parts of a kit and may be mixed together prior to spraying. In a separate embodiment, at least one adjuvant may also be included with the kit and mixed together with the electrolytic agrochemicals.

The composition of the present disclosure may be applied simultaneously as a tank mix of formulation including both the electrolytic agrochemical and an additional active ingredient, or the liquid agrochemical composition and additional active ingredient may be applied sequentially.

Advantages of the present invention include:
a) The liquid agrochemical compositions described herein are highly efficacious at controlling weeds.
b) The electrolytic agrochemical in the liquid agrochemical compositions remains stable over a period of time when stored at various temperatures.
c) The liquid agrochemical compositions provide consistent weed control under different parameters of weather conditions such as time of application, temperature, wind speed and humidity.
d) The liquid agrochemical compositions provide consistent weed control across a broad spectrum of weeds.
e) The liquid agrochemical compositions provide consistent weed control irrespective of the morphological structure of the leaves of the weeds.

Further advantages and other parameters of the present disclosure are illustrated by the below given examples. However, the scope of the present disclosure is not limited by the examples in any manner. It will be appreciated by any person skilled in this art that the present disclosure includes aforesaid examples and further can be modified and altered within the technical scope of the present disclosure.

### EXAMPLES

Working Examples 1-6, 8-11, and 14-20 are inventive compositions according to the present disclosure and are presented in Tables 1 to 5 below. Comparative Example compositions (compositions not according to the present invention) (examples 7, 12, 13 and 21) are also presented in Table 6. The process used to prepare the compositions in Tables 1-6 is described in further detail below.

### Example 1

TABLE 1
COMPOSITIONS COMPRISING L-GLUFOSINATE
AMMONIUM OF EXAMPLE 1

| Ingredient | Quantity (% wt/wt) |
|---|---|
| L-Glufosinate ammonium (50% aqueous | 25.77 |
| solution) | |
| Propylene glycol | 18 |
| Ethylene glycol monobutyl ether | 5 |
| Potassium chloride | 0.5 |
| C_{8/10} Alkyl glucamide | 4.5 |
| Polyethylene glycol monotridecyl ether | 4.5 |
| phosphate | |
| Decylamine oxide | 21 |
| Water | Q.S. |
| Total | 100 |

### Process of Preparing Composition of Example 1

Required quantity of L-glufosinate ammonium was mixed with water, propylene glycol and ethylene glycol monobutyl ether followed by the addition of the calculated amount of C_{8/10} alkyl glucamide, polyethylene glycol monotridecyl ether phosphate, decylamine oxide and potassium chloride. The resultant mixture was homogenised to obtain the liquid herbicidal composition.

TABLE 2
COMPOSITIONS COMPRISING GLUFOSINATE
AMMONIUM OR L-GLUFOSINATE AMMONIUM

| | Working Examples | | | | |
|---|---|---|---|---|---|
| Ingredients | Example 2 | Example 3 | Example4 | Example 5 | Example 6 |
| Glufosinate ammonium | — | — | 18.70 | — | — |
| L-glufosinate ammonium (50% | 18.70 | 25.77 | — | 18.70 | 13.70 |
| aqueous solution) | | | | | |
| Propylene glycol | 18.00 | 20.00 | 18.00 | 16.00 | 15.00 |
| Glycol ether | 5.00 | 4.50 | 4.50 | 5.00 | 7.00 |
| Alkali salt | 1.25 | 0.50 | 0.50 | 1.25 | 4.00 |
| C₈-C₁₀ alkyl polyglucoside | — | — | — | 12.00 | 12.00 |
| Alkyl glucamide | 12.00 | 12.00 | 10.0 | — | — |
| Alkyl ether phosphate | 12.00 | 12.00 | 6.00 | 12.00 | 12.00 |
| C₁₂-alkyl amine oxide | 24.00 | 24.00 | 25.00 | 24.00 | 24.00 |
| Water | Q.S | Q.S | Q.S | Q.S | Q.S |

Composition of examples 2-6 were prepared according to process of example 1.

TABLE 3
COMPOSITIONS COMPRISING GLUFOSINATE
AMMONIUM OR L-GLUFOSINATE AMMONIUM

| | Working Examples | | | |
|---|---|---|---|---|
| Ingredients | Example 8 | Example 9 | Example 10 | Example 11 |
| Glufosinate ammonium | — | — | — | 18.7 |
| L-glufosinate ammonium (50% | 25.77 | 25.77 | 18.7 | — |
| aqueous solution) | | | | |
| Alkyl glucamide | — | 13.0 | 12.0 | 10.0 |
| C₈-C₁₀ Alkyl polyglucoside | 12.0 | — | — | — |
| C₁₂-Alkyl amine oxide | 24.0 | 14.0 | 24.0 | 25.0 |
| C₁₃-C₁₅ alkyl amine oxide | — | 5.0 | — | 0.00 |
| Propylene glycol | 17.0 | 21.0 | 21.0 | 18.0 |
| Alkali salt | 0.5 | 0.5 | 1.25 | 0.50 |
| Alkyl ether phosphate | 12.0 | 14.0 | 12.0 | 6.0 |
| Ethylene glycol monobutyl ether | 6.0 | 5.5 | 5.0 | 4.5 |
| Water | Q.S | Q.S | Q.S | Q.S |

Composition of examples 8-11 were prepared according to process of example 1.

TABLE 4
COMPOSITIONS COMPRISING L-GLUFOSINATE AMMONIUM

| | Working Examples | | | | |
|---|---|---|---|---|---|
| Ingredients | Example 14 | Example 15 | Example 16 | Example 17 | Example 18 |
| L-glufosinate ammonium | 25.77 | 18.7 | 18.7 | 13.7 | 25.77 |
| Alkyl glucamide | — | 12 | — | 12 | 11 |
| C₈—C₁₀Alkyl polyglucoside | 11 | — | 11 | — | — |
| C₁₀ alkylamine oxide | 7 | 7 | 7 | 7 | 7 |
| C₁₃—C₁₅ alkyl amine oxide | 8 | 8 | 8 | 8 | 8 |
| Propylene glycol | 17 | 20 | 17 | 17 | 20 |
| Alkali salt | 0.25 | 1.25 | 1.25 | 4.5 | 0.25 |
| Alkyl ether phosphate | 15 | 15 | 15 | 15 | 15 |
| Ethylene glycol monobutyl ether | 7 | 5.5 | 7 | 5.5 | 5.5 |
| Water | Q.S | Q.S | Q.S | Q.S | Q.S |

### Process of Preparing Composition Examples 14-18

Required quantity of L-glufosinate ammonium, propylene glycol and ethylene glycol monobutyl ether were mixed with slow agitation in formulation vessel to obtain a dispersion. C₈-C10 Alkyl polyglucoside and/or alkyl glucamide, alkyl ether phosphate, C₁₀ alkylamine oxide, C₁₃-C₁₅ alkyl amine oxide and potassium chloride were then added to the dispersion. Water was then added to resultant mixture and the mixture was agitated for 90 minutes at temperature 20-35° C. to obtain the liquid herbicidal composition.

TABLE 5
COMPOSITIONS COMPRISING L-GLUFOSINATE
AMMONIUM AND A SECOND ACTIVE INGREDIENT

Working Examples

| Ingredients | Example 19 | Example 20 |
|---|---|---|
| 2,4-amine salt | — | 18 |
| Glyphosate IPA salt | 15 | — |
| L-glufosinate ammonium | 14.2 | 18 |
| Alkyl glucamide | — | — |
| C₈—C₁₀Alkyl polyglucoside | 8 | 10 |
| C₁₀ alkylamine oxide | 10 | 10 |
| C₁₃—C₁₅ alkyl amine oxide | 10 | — |
| Propylene glycol | 17 | 15 |
| Alkali salt | 0.25 | 0.25 |
| Alkyl ether phosphate | 15 | 15 |
| Ethylene glycol monobutyl ether | 10 | 10 |
| Water | Q.S | Q.S |

Composition of examples 19-20 were prepared according to process of example 14.

TABLE 6
COMPARATIVE EXAMPLES

| Ingredients | Example 7 | Example 12 | Example 13 | Example 21 |
|---|---|---|---|---|
| L-glufosinate | 25.77 | 25.77 | 25.77 | 25.77 |
| ammonium (50% | | | | |
| aqueous solution) | | | | |
| Propylene glycol | 17.00 | 17.0 | 17.0 | 10 |
| Glycol ether | 7.00 | 7.0 | 7.0 | 2 |
| Alkali salt | 1.25 | 1.25 | — | — |
| C₈—C₁₀ alkyl | — | 11.0 | — | — |
| polyglucoside | | | | |
| Alkyl ether | — | — | 15.0 | — |
| phosphate | | | | |
| C₁₀/C₁₂-alkyl | 15.00 | — | — | 20 |
| amine oxide | | | | |
| Water | Q.S | Q.S | Q.S | Q.S |

Composition of examples 7, 12, 13 and 21 were prepared according to process of example 1.

### Determination of Dynamic Surface Tension (DST)

The dynamic surface tension (DST) of the samples of working and comparative examples was determined via the bubble pressure method using a bubble pressure tensiometer, model-BP100 (KRUSS) during a time period (surface age or bubble age) of 20-50 milliseconds as relevant for the spray application of agrochemicals in aqueous dilution. Samples of the above-described formulations were prepared for analysis by diluting the formulated product in water at a concentration of 150-400 grams active ingredient per hectare (g ai/h) of L-glufosinate ammonium and 300-900 g active ingredient per hectare of glufosinate ammonium. Dynamic surface tension was measured from bubble age of 20 milliseconds to 50 milliseconds at room temperature 25±2° C. and a relative humidity (rH)=65-75%.

The below Tables 7 and 8 summarize the DST of the Example formulations. Corresponding spray compositions (comp) used for testing the samples are indicated in the tables in brackets. The DST of Comparative Example compositions (compositions not according to the present invention) is presented in Table 9.

TABLE 7
DST (MN/M) OF FORMULATIONS PREPARED
ACCORDING TO THE PRESENT DISCLOSURE

| | Sample 1 | Sample 2 | Sample 3 | Sample 4 | Sample 5 | Sample 6 |
|---|---|---|---|---|---|---|
| Time | (composition of | (composition of | (composition of | (composition of | (composition of | (composition of |
| [ms] | example 2) | example 3) | example 6) | example 8) | example 9) | example 11) |
| 20 | 50.6 | 55.2 | 49.7 | 41.6 | 51.3 | 40.4 |
| 30 | 47.2 | 51.7 | 46.4 | 40.9 | 49.5 | 40 |
| 40 | 45.4 | 49.4 | 44.4 | 40.6 | 49.1 | 39.6 |
| 50 | 43.9 | 47.7 | 43.1 | 40 | 48.8 | 39.3 |

TABLE 8
DST (MN/M) OF FORMULATIONS PREPARED ACCORDING TO THE PRESENT DISCLOSURE

| | Sample 7 | Sample 8 | Sample 9 | Sample | Sample 10 | Sample 11 | Sample 12 |
|---|---|---|---|---|---|---|---|
| Time | (composition of | (composition of | (composition of | (composition of | (composition of | (composition of | (composition of |
| [ms] | example 14) | example 15) | example 16) | example 17) | example 18) | example 19) | example 20) |
| 20 | 56.35 | 51.62 | 50.19 | 49.04 | 57.03 | 41.1 | 43.3 |
| 30 | 52.77 | 49.26 | 48.03 | 46.69 | 53.93 | 40.0 | 42.6 |
| 40 | 50.51 | 47.61 | 46.04 | 44.71 | 51.88 | 39.6 | 42.0 |
| 50 | 48.89 | 45.92 | 44.82 | 43.42 | 50.25 | 39.0 | 41.3 |

TABLE 9
DST (MN/M) OF COMPARATIVE EXAMPLE
COMPOSITIONS (COMPOSITIONS NOT ACCORDING
TO THE PRESENT INVENTION)

| | Sample 13 | Sample 14 | Sample 15 | Sample 16 |
|---|---|---|---|---|
| Time | (composition of | (composition of | (composition of | (composition of |
| [ms] | example 7) | example 12) | example 13) | example 21) |
| 20 | 65.3 | 67.7 | 67.28 | 70.56 |
| 30 | 63.5 | 66.3 | 66.19 | 70.20 |
| 40 | 62 | 65.1 | 65.31 | 70.03 |
| 50 | 61.2 | 64.2 | 64.61 | 69.72 |

It is evident from the above results that a spray dilution of the formulation of L-glufosinate ammonium, including a combination of a non-hydrotrope phosphorus derivative such as an alkyl ether phosphate, a surfactant (e.g., alkyl dimethyl amine oxide), and an alkali metal salt, when tested at a spray dilution, has a dynamic surface tension less than 60 mN/in over a bubble surface age of 20-50 milliseconds. Samples prepared for compositions of Examples 7, 12, and 13 and 21 which do not contain the compositions according to the present disclosure, when tested at a spray dilution, have a dynamic surface tension greater than 60 mN/in over a bubble surface age of 20-50 milliseconds.

### Rio-Efficacy of the Formulations According to the Present Disclosure

Field trials were carried out using the compositions prepared according to the present disclosure as the broad-spectrum herbicide. The compositions were diluted with water and optionally with other tank mix auxiliaries and applied at an application rate of 150-400 g active ingredient per hectare of L-glufosinate ammonium and 300-900 g active ingredient per hectare of glufosinate ammonium, to crop and non-crop land containing many broad leaf weeds, grasses and sedges. Various samples prepared according to embodiment of the disclosure were tested for their efficacy in controlling the weeds. Corresponding compositions used for preparing the samples are indicated in the tables (in brackets). Samples prepared for the bio-efficacy determination are independent of the samples prepared for DST determination and therefore, sample numbers may not match in some cases, for example, sample 5 for DST determination was prepared from composition of one example and sample 5 for bio-efficacy determination was prepared from composition of another example. Efficacy of comparative example composition is presented in Table 20 for comparison with efficacy that of the working example compositions.

The protocol for testing samples 1 and 2 is shown in Table 10 and the weed control results are shown in Table 11.

TABLE 10
PROTOCOL FOR THE FIELD TREATMENT
FOR SAMPLES 1-2

| Sr No | Particular | Details |
|---|---|---|
| 1. | Crop | Non crop area |
| 2. | Type of Nozzle | Flat Fan |
| 3. | Treatment Dose | 210 g a.i/ha |
| 4. | Stage of weeds | 2-4″ height |

TABLE 11
% WEED CONTROL

| | Percent weed control at 9 DAT | |
|---|---|---|
| | Chinopodium | Amaranthus |
| Sample | album | palmeri |
| Sample 1 (composition of example 2) | 73 | 77 |
| Sample 2 (composition of example 3) | 77 | 78 |

The protocol for testing samples 3-5 is shown in Table 12 and the weed control results are shown in Table 13.

TABLE 12
PROTOCOL FOR THE FIELD TREATMENT
FOR SAMPLES 3-5

| Sr No | Particular | Details |
|---|---|---|
| 1. | Crop | Non crop area |
| 2. | Type of Nozzle | Flat Fan |
| 3. | Treatment Dose | 157.5 g a.i/ha |
| 4. | Stage of weeds | 2-4″ height |

TABLE 13
% WEED CONTROL

| | Percent weed control at 14 DAT |
|---|---|
| Sample | (Brachiaria plantaginea) |
| Sample 3 (composition of example1) | 79.7 |
| Sample 4 (composition of example 2) | 78.3 |
| Sample 5 (composition of example 3) | 76.7 |

The protocol for testing sample 6 is shown in Table 14 and the weed control results are shown in Table 15.

TABLE 14
PROTOCOL FOR THE FIELD TREATMENT

| Sr No | Particular | Details |
|---|---|---|
| 1. | Crop | Non crop area |
| 2. | Type of Nozzle | Flat Fan |
| 3. | Treatment Dose | 157.5 g a.i/ha |
| 4. | Stage of weeds | 2-4″ height |

TABLE 15
% WEED CONTROL

| | Percent weed control at 21 DAT |
|---|---|
| Sample | (Amaranthus viridis) |
| Sample 6 (composition of example 5) | 88.7 |

The protocol for testing samples 7-10 is shown in Table 16 and the weed control results are shown in Tables 17 and 18.

TABLE 16
PROTOCOL FOR THE FIELD TREATMENT

| Sr No | Particular | Details |
|---|---|---|
| 1 | Crop | Non crop area |
| 2 | Type of Nozzle | Flat Fan |
| 3 | Treatment Dose | 210 g a.i/ha |
| 4 | Stage of weeds | 2-4″ height |

TABLE 17
% WEED CONTROL

| | Percent weed control at 9 DAT |
|---|---|
| Sample | Green fox tail |
| Sample 7 (composition of example 15) | 88.3 |
| Sample 8 (composition of example 16) | 91.67 |

TABLE 18
% WEED CONTROL

Percent weed control at 9 DAT

| | Green | Morning | Volunteer |
|---|---|---|---|
| Sample | fox tail | Glory | soybean |
| Sample 9 (composition of | 83.3 | 73.3 | 70.0 |
| example 14) | | | |
| Sample10 (composition of | 86.6 | 76.7 | 73.0 |
| example 18) | | | |

The protocol for testing Sample 11 is shown in Table 19 and the weed control results are shown in Table 20.

TABLE 19
PROTOCOL FOR THE FIELD TREATMENT

| Sr No | Particular | Details |
|---|---|---|
| 1 | Crop | Non crop area |
| 2 | Type of Nozzle | Flat Fan |
| 3 | Treatment Dose | 250 g a.i/ha |
| 4 | Stage of weeds | 2-4″ height |

TABLE 20
% WEED CONTROL

| | Percent weed control at 3 DAT | | |
|---|---|---|---|
| | Volunteer | Brachiaria | Eleusine |
| Sample | soybean | decumbens | indica |
| Sample 11 (composition of | 42.5 | 45.0 | 42.5 |
| example 21) | | | |

Analysis of the data in the above tables show that L-glufosinate ammonium formulations prepared according to the present disclosure exhibited good weed control when tested under various treatment doses. It was further surprisingly found that the efficacy of the formulation could be controlled by modulating the dynamic surface tension, and that formulations having a dynamic surface tension less than 60 mN/m between a surface age of 20-50 milliseconds provided surprisingly higher efficacy. Compositions according to the present disclosure when tested at a treatment dose of 157.5 g a.i/ha exhibited acceptable weed control whereas comparative compositions even when tested at a higher treatment dose of 250 g a.i/ha, the weed control was found to be inadequate.

1. A liquid agrochemical composition comprising:
a) 5% to 40% by weight of L-glufosinate ammonium;
b) 0.1% to 30% by weight of a non-hydrotrope phosphorus derivative comprising a C8-C20 fatty alcohol ethoxylate phosphate ester, polyethylene glycol monotridecyl ether phosphate or a combination thereof;
c) 1% to 40% by weight of a surfactant selected from C8-C10 alkyl polyglycoside or N-alkyl glucamide or a decyl-dimethylamine N-oxide, and
d) 0.1% to 20% by weight of potassium chloride.

2. The composition as claimed in claim 1, wherein said composition comprises at least one solvent selected from propylene glycol, ethylene glycol monobutyl ether.

3. A method of controlling weeds, said method comprising applying to the plants or to their locus, an agrochemical liquid composition as claimed in claim 1.

4. The composition of claim 1, wherein the agrochemical liquid composition further comprises an additional active ingredient, wherein the additional active ingredient is glyphosate.
